(19) United States
(12) Patent Application Publication
(10) Pub. No.: US 2009/0293197 A1
(43) Pub. Date: Dec. 3, 2009

(54) WIDTH ADJUSTMENT ACCESSORY FOR USE WITH BEDS

(75) Inventors: Douglas A. Larson, Plover, WI (US); James R. Risk, Jr., Plover, WI (US); Troy T. Clendenning, Stevens Point, WI (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: JOERNS HEALTHCARE INC., Stevens Point, WI (US)

(21) Appl. No.: 12/475,978

(22) Filed: Jun. 1, 2009

Related U.S. Application Data
(60) Provisional application No. 61/130,504, filed on May 30, 2008.

(51) Int. Cl. A47C 19/04; A47C 31/00; A61G 7/002

(52) U.S. Cl. 5/618; 5/658; 5/613; 5/185

(57) ABSTRACT

This invention relates to a bed including a frame with a substantially planar frame support surface. The bed also includes a width adjustment accessory with a mounting member and an extension member, the extension member providing a substantially planar extended support surface. The mounting member is configured to be attached relative to the frame so that the extended support surface is substantially planar with the frame support surface.

### CROSS-REFERENCE TO RELATED APPLICATIONS

This application claims the benefit of U.S. Provisional Application No. 61/130504, filed May 30, 2008, the disclosure of which is incorporated herein by reference.

### BACKGROUND OF THE INVENTION

This invention relates in general to beds and more particularly to attachments or accessories for use with beds. Most particularly, the invention relates to a width adjustment accessory for use with beds in the healthcare industry.

Beds for use in the healthcare industry typically have a base frame that is raised and lowered in relation to a supporting surface and a patient support surface that has portions that tilt or move in relation to the base frame. Such beds are typically referred to as articulating beds. Examples of articulating beds include products marketed as ULTRACARE™ and 530 Series beds by Joerns Healthcare Inc. of Stevens Point, Wis. Other beds include the CS7 model bed by Invacare Corporation of Elyria, Ohio, the Zenith by Graham-Field Health Products, Inc. of Atlanta, Ga., and the 100 model bed by Hill-Rom Services, Inc. of Wilmington, Del. Standard articulating beds are generally about 35 inches wide. Twin beds are generally about 39 inches wide. Bariatric beds are generally 48-52 inches wide. If a bariatric bed is needed, the bariatric bed must be removed from inventory and delivered for use and the standard articulating bed has to be stored in inventory or packed and shipped. Maintaining a proper inventory of different size beds can be costly and space consuming and the final cost is high for packing and shipping the beds.

### SUMMARY OF THE INVENTION

This invention relates to a bed including a frame with a substantially planar frame support surface. The bed also includes a width adjustment accessory with a mounting member and an extension member, the extension member providing a substantially planar extended support surface. The mounting member is configured to be attached relative to the frame so that the extended support surface is substantially planar with the frame support surface.

This invention also relates to an accessory for use with beds, the accessory comprising a width adjustment accessory including a mounting member, and an extension member attached to the mounting member. The extension member provides a substantially planar extended support surface. The accessory also comprises a second width adjustment accessory including a second mounting member, and a second extension member attached to the second mounting member. The second extension member providing a substantially planar second extended support surface. The width adjustment accessory and second width adjustment accessory are configured to be mounted on opposite sides of a frame support surface, so that the extended support surface and the second extended support surface are substantially planar with the frame support surface.

This invention also relates to a bed comprising a frame supporting a substantially planar head frame support surface, a substantially planar body frame support surface, and a substantially planar foot frame support surface. The bed also includes a head extension that includes a head mounting member and a head extension member, the head extension member defining a substantially planar head extended surface. The head extension is configured to attach relative to the frame so that the head extended support surface is substantially planar with the head frame support surface. The bed also includes a second head extension that includes a second head mounting member and a second head extension member, the second head extension member defining a substantially planar second head extended surface. The second head extension is configured to attach relative to the frame so that the second head extended support surface is substantially planar with the head frame support surface. The bed also includes a body extension that includes a body mounting member and a body extension member, the body extension member defining a substantially planar body extended surface. The body extension is configured to attach relative to the frame so that the body extended support surface is substantially planar with the body frame support surface. The bed also includes a second body extension that includes a second body mounting member and a second body extension member, the second body extension member defining a substantially planar second body extended surface. The second body extension is configured to attach relative to the frame so that the second body extended support surface is substantially planar with the body frame support surface. The bed also includes a foot extension that includes a foot mounting member and a foot extension member, the foot extension member defining a substantially planar foot extended surface. The foot extension is configured to attach relative to the frame so that the foot extended support surface is substantially planar with the foot frame support surface. The bed also includes a second foot extension that includes a second foot mounting member and a second foot extension member, the second foot extension member defining a substantially planar second foot extended surface. The second foot extension is configured to attach relative to the frame so that the second foot extended support surface is substantially planar with the foot frame support surface. The bed is articulated and the head frame support surface is moveable relative to the body frame support surface. The body width adjustment accessory and the second width adjustment accessory remain substantially planar with the head frame support surface. Further, the body width adjustment accessory and the second body width adjustment accessory remain substantially planar with body frame support surface.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a bed with attached width adjustment accessories.

FIG. 2 is a plan view, from above, of the bed of FIG. 1.

FIG. 3 is a perspective view of a portion of the bed and one width adjustment accessory of FIG. 1.

FIG. 3a is a cross sectional view, taken from the end, of the width adjustment accessory of FIG. 3.

FIG. 4 is a cross sectional view, taken from the end, of an alternative width adjustment accessory.

FIG. 5 is a perspective view of a portion of a second bed and a second width adjustment accessory.

FIG. 6 is a cross sectional view, taken from the end, of an alternative second width adjustment accessory.

FIG. 7 is a perspective view of a portion of a third bed and a third width adjustment accessory.

FIG. 8 is a cross sectional view, taken from the end, of an alternative third width adjustment accessory.

FIG. 9 is a cross sectional view, taken from the end, of a different embodiment of a width adjustment accessory.

FIG. 10 is a perspective view of a portion of a fourth bed and a fourth width adjustment accessory.

FIG. 11 is a cross sectional view, taken from the end, of an alternative fourth width adjustment accessory.

FIG. 12 is a cross section view, taken from the end, of a bed with hinged width adjustment accessories, the width adjustment accessories including telescopic extension members.

### DETAILED DESCRIPTION OF THE PREFERRED EMBODIMENT

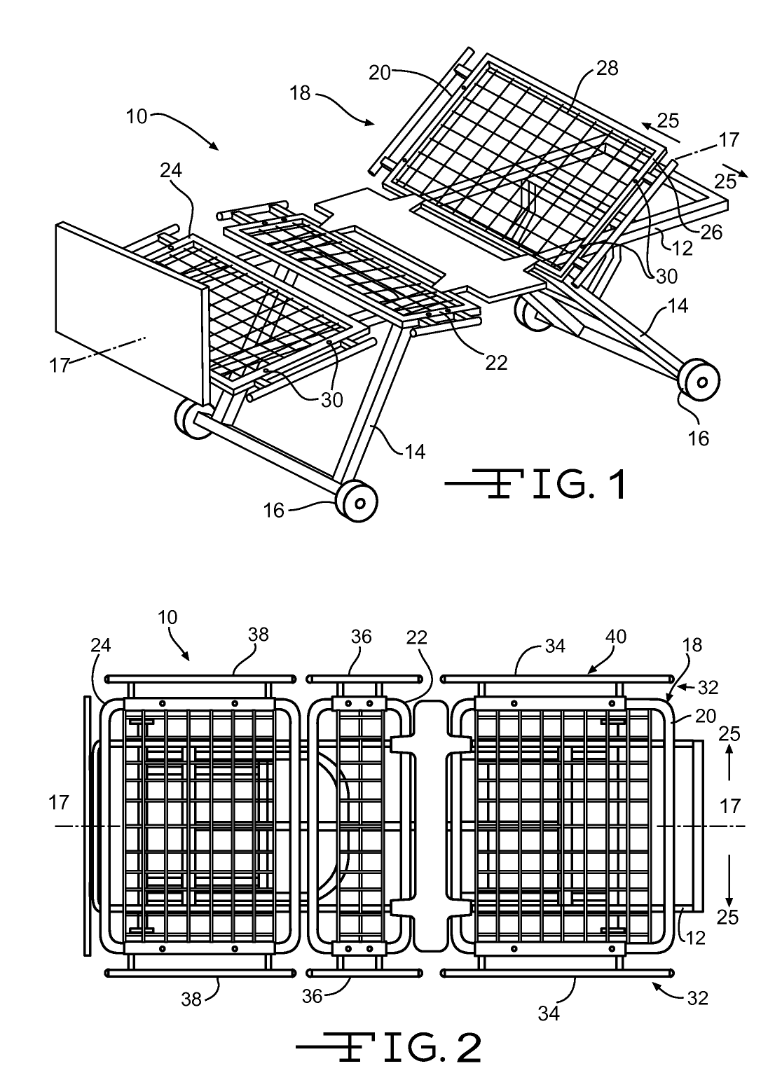

Referring now to the drawings, there is illustrated in FIG. 1 a perspective view of an elongated bed, indicated generally at 10. The bed 10 is an articulating bed, of the kind used in a healthcare industry. It should be appreciated that the bed 10 does not need to be capable of articulation, and this particular bed is used for non-limiting, illustrative purposes only. The bed 10 includes an elongated frame 12. The frame 12 is supported by legs 14. Legs 14 are supported by feet or wheels 16 on a support surface. The bed 10 is longer than it is wide, and has a longitudinal axis 17 along the length of the bed 10.

The bed 10 includes a frame patient support surface, indicated generally at 18. The illustrated frame patient support surface 18 is made up of three individual sections that are supported on the frame 12. These are the head section 20, the seat section 22 and the foot section 24. The three sections 20, 22 and 24 are arranged serially along the longitudinal axis 17 of the bed 10. The three sections 20, 22 and 24 extend laterally across the width of the bed 10, in a direction indicated by arrows 25 transverse to the longitudinal axis 17. These three sections are used for illustrative purposes only, and it should be appreciated that the bed 10 can have a different number of sections, or a different configuration of sections from that illustrated. Each of the sections of the frame patient support surface 18 is moveable relative to the frame 12 and relative to the other sections. The illustrated sections are made of tubular members 26 that support a wire structure 28. It should be appreciated that the frame patient support surface 18 can be made in a different manner than this. The frame patient support surface 18 generally supports a mattress (not shown) for use by a patient. The frame patient support surface 18 also includes a mounting structure. In the illustrated bed 10, the mounting structure is a series of holes 30 through the tubular member 26.

Referring now to FIG. 2, there is shown a plan view, from above, of the bed 10, with width adjustment accessories, indicated generally at 32, attached. The illustrated width adjustment accessories 32 include head section extensions 34, seat section extensions 36, and foot section extensions 38. The extensions 34, 36 and 38 include two extensions attached to opposite sides of each of the respective sections 20, 22 and 24 comprising the frame patient support surface 18. With the width adjustment accessories 32 attached the bed 10 has a second patient support surface 40 which is wider that the frame patient support surface 18. The second patient support surface 40 is configured to support a second mattress (not shown). The second mattress has the same length as the first mattress but is wider. It should be appreciated that the width adjustment accessories 32 do not need to include opposite extensions on each side of the bed 10, but instead could be placed on only one side of the bed 10. Also, it should be appreciated that the width adjustment accessories 32 can include different width extensions on the different sections, in order to provide desired configurations of the second patient support surface 40.

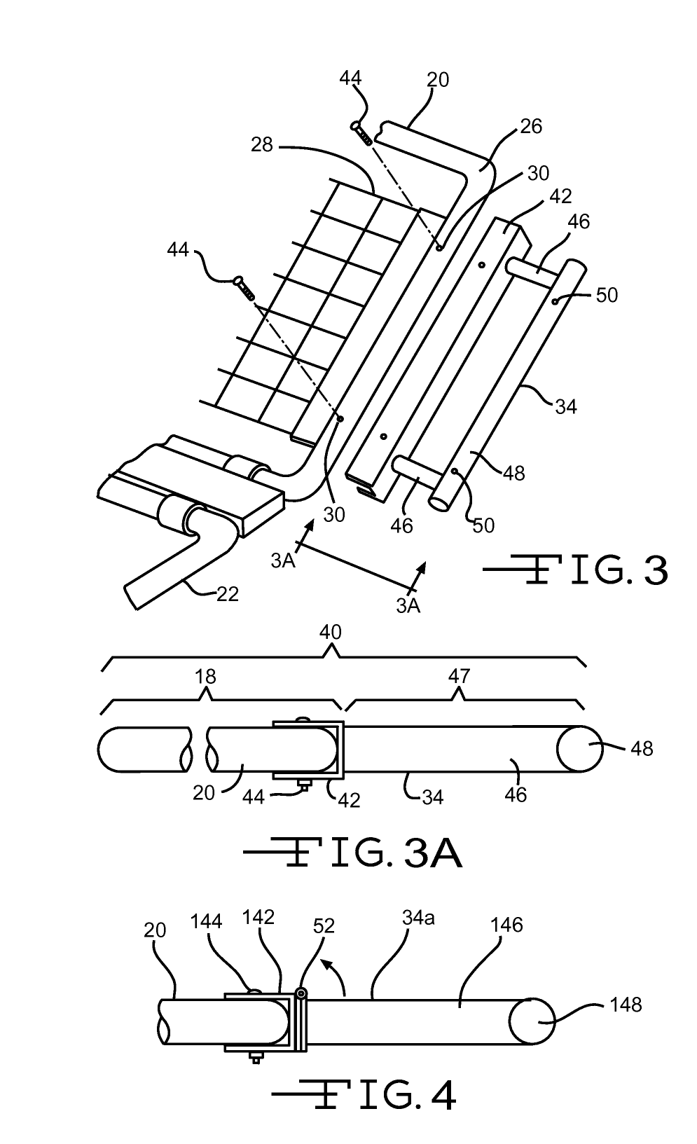

Referring now to FIG. 3, a perspective view of one of the head section extensions 34 and one tubular member 26 of the head section 20 is shown. The remaining portions of the bed 10 are not shown in FIG. 3 for clarity. The illustrated head section extension 34 includes a mounting member 42. The illustrated mounting member 42 is a C-shaped channel. It should be appreciated that the mounting member 42 can have a shape different from that illustrated. The mounting member 42 can be made of metal, plastic, or other desired materials. The mounting member may be fixed relative to the tubular member 26 by a fastener such as quick release pins 44. The quick release pins 44 are passed through the mounting member 42 and through the holes 30 in the tubular member 26. It should be appreciated that fasteners other that quick release pins may be used, including threaded fasteners, clips, adhesives, welding, or other desired fasteners.

The head section extension 34 also includes two extension members 46 attached to the mounting member 42. It should be appreciated that while the illustrated head section extension 34 includes two extension members 46, some other number of extension members may be used as desired. Further, it should be appreciated that the extension members 46 do not have to be separate from the other components of the head section extension 34. For example, the mounting member 42 could extend further in the lateral direction 25, and extension member 46 can be omitted. Also, the illustrated extension members 46 have a fixed length, but it should be appreciated that the extension members 46 may have an adjustable length in the lateral direction 25.

As best seen in FIG. 3a, the extensions members 46 provide a substantially planar extended support surface 47. It should be appreciated that the extended support surface 47 combines with the frame patient support surface 18 to create the second patient support surface 40. In the illustrated embodiment, the extended support surface 47 is made from the mounting member 42, the extension members 46, and a support member 48. It should be appreciated that additional components may be provided to create the extended support surface 47. For example, a wire structure (not shown) may be attached between the mounting member 42 and the support member 48.

In the illustrated embodiment, when the head section extension 34 is attached to the bed 10 the extended support surface 47 is substantially coplanar with the frame patient support surface 18. This is not necessary, and the head section extension 34 can be configured so that the extended support surface 47 is not substantially coplanar with the frame patient support surface 18. The extended support surface 47 may be parallel to the frame patient support surface 18 but offset from it, or the extended support surface 47 may be non-parallel to the frame patient support surface 18, for example.

Referring back to FIG. 3, the head section extension 34 includes the support member 48 attached to the outer ends of the extension members 46. The illustrated support member 48 is a tubular member, but the support member 48 may have other desired shapes. The support member 48 includes an optional accessory mounting structure 50. The illustrated accessory mounting structure 50 is a pair of vertically-oriented holes configured for the mounting of a bed rail (not shown). It should be appreciated that the accessory mounting structure 50 may be configured for the mounting of other desired accessories. It should also be appreciated that the accessory mounting structure 50 may have a configuration different from that illustrated. For example, the accessory mounting structure 50 may include horizontally-oriented holes, clamps, brackets, or other desired configurations.

Referring back to FIG. 2, the illustrated width adjustment accessories 32 include extensions 34, 36 and 38 that have the same general configuration as the head section extension 34 described in detail above. It should be appreciated that different sections of the bed 10 may have extensions with a different configuration. Also, the extensions on opposite sides of the bed may be different from each other.

Referring to FIG. 4, there is illustrated an elevational view, the view taken from the end, of an alternative head section extension 34a. The alternative head section extension 34a includes a mounting member 142, an extension member 146 and a support member 148. The mounting member 142 may be fixed relative to the tubular member 26 by a fastener such as quick release pins 144. The alternative head section extension 34a may be provided with a hinge connection 52 that may allow the support member 148 to flip up relative to the mounting member 142. This allows the support member 148 to be folded over on top of the head section 20 (e.g., counter-clockwise in FIG. 4, in the direction of the arrow shown) or rotated onto the support surface. This allows for ease of transportation and more compact storage. With the alternative head section extension 34a flipped up and folded over onto the movable sections, the bed may be passed through a doorway that is too narrow for the passage of the extended width bed without removing the alternative head section extension 34a. It should be appreciated that a spring or a lock (neither shown) may be provided for holding the alternative head section extension 34a in place. It should be appreciated that the components on the other sections of the bed 10 may include hinged connections similar to hinge connection 52. Also, it should be appreciated that the hinge connection 52 may be configured to allow the support member 148 to fold underneath the head section 20 (e.g., clockwise as viewed in FIG. 4). Additionally, the amount of rotation possible may be limited, if desired.

The width adjustment accessories 32 may be configured to attach to a variety of existing beds. This includes beds that are made for the attachment of an existing accessory, such as a side rail. In that situation, the mounting member 42 may be configured to take advantage of the existing mounting structure so that the mounting member 42 can be attached to an attachment structure already on the bed. Further, the accessory mounting structure 50 on the support member 48 may be configured to accommodate the existing accessory of the existing bed. For example, an existing bed may have a detachable side rail. A width adjustment accessory may be manufactured which may attach to existing side rail mounts on the bed. The width adjustment accessory may also include an accessory mounting structure that the existing side rail may be attached to. This would allow a user to remove the side rail from the existing bed, attach the width adjustment accessory in order to provide a wide patient support surface, and then attach the side rail to the wider bed.

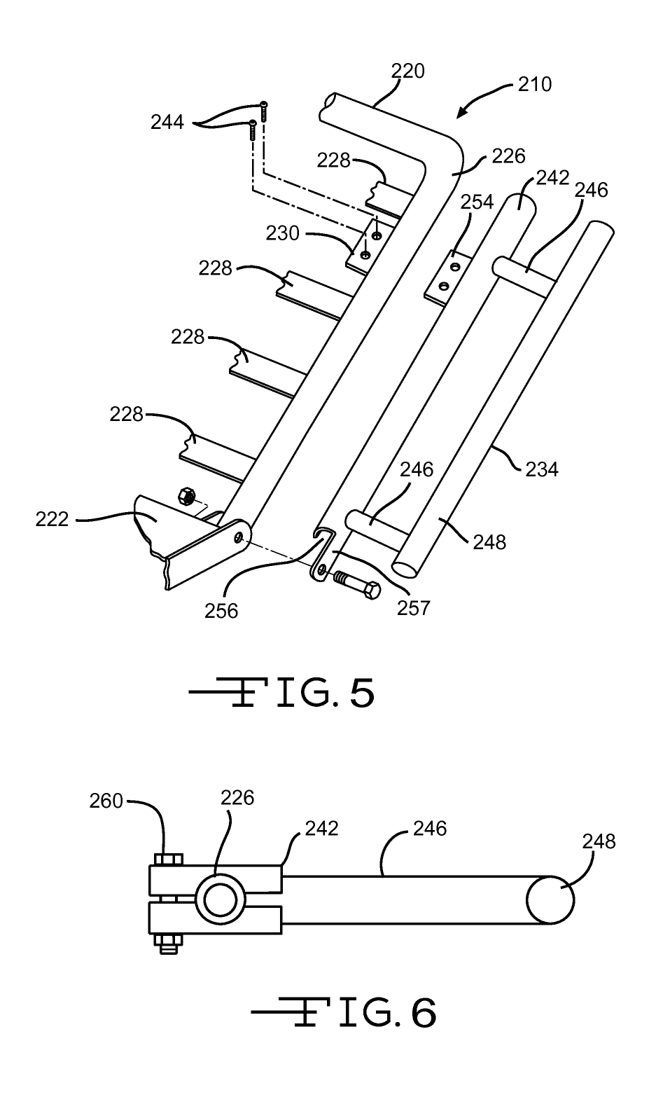

Referring now to FIG. 5, there is shown a portion of a head section 220 and a portion of a seat section 222 of a second bed 210. The head section 220 includes tubular member 226 supporting transverse members 228. The head section 220 also includes a mounting tab 230. A second head section extension 234 is configured to attach to the head section 220. The second head section extension 234 includes a mounting member 242, two extension members 246, and a support member 248. The second head section extension 234 also includes a cooperating mount 254. The mounting member 242 defines a channel 256, and is configured to capture at least a portion of the tubular member 226 when the second head section extension 234 is attached to the second bed 210. The cooperating mount 254 may be aligned with the mounting tab 230 so that fasteners, such as quick release pins 244, may fix the cooperating mount 254 relative to the mounting tab 230.

The mounting member 242 also includes a pivot flange 257. The pivot flange 257 is configured to allow a pivot pin 258 to help fix the mounting member 242 relative to the tubular member 226, while allowing movement of the head section 220 relative to the seat section 222. It should be appreciated that the mounting member 242 may be fixed relative to the tubular member 226 in other desired manners, such as shown in FIG. 6 by a clamp 260.

Referring now to FIG. 7, there is shown a head section 320 and a portion of a seat section 322 of a third bed 310. The head section 320 includes angular members 326 supporting transverse members 328 and a wire structure 328a. A third head section extension 334 includes a mounting member 342, three extension members 346 and a support member 348. The illustrated mounting member 342 is a flat, elongated bar. However, the mounting member may be any desired configuration, such as an angular member. The mounting member 342 is fixed relative to the angular member 326 using fasteners 344. Alternatively, quick release pins, threaded fasteners, adhesives, welding, or other desired fasteners may be used.

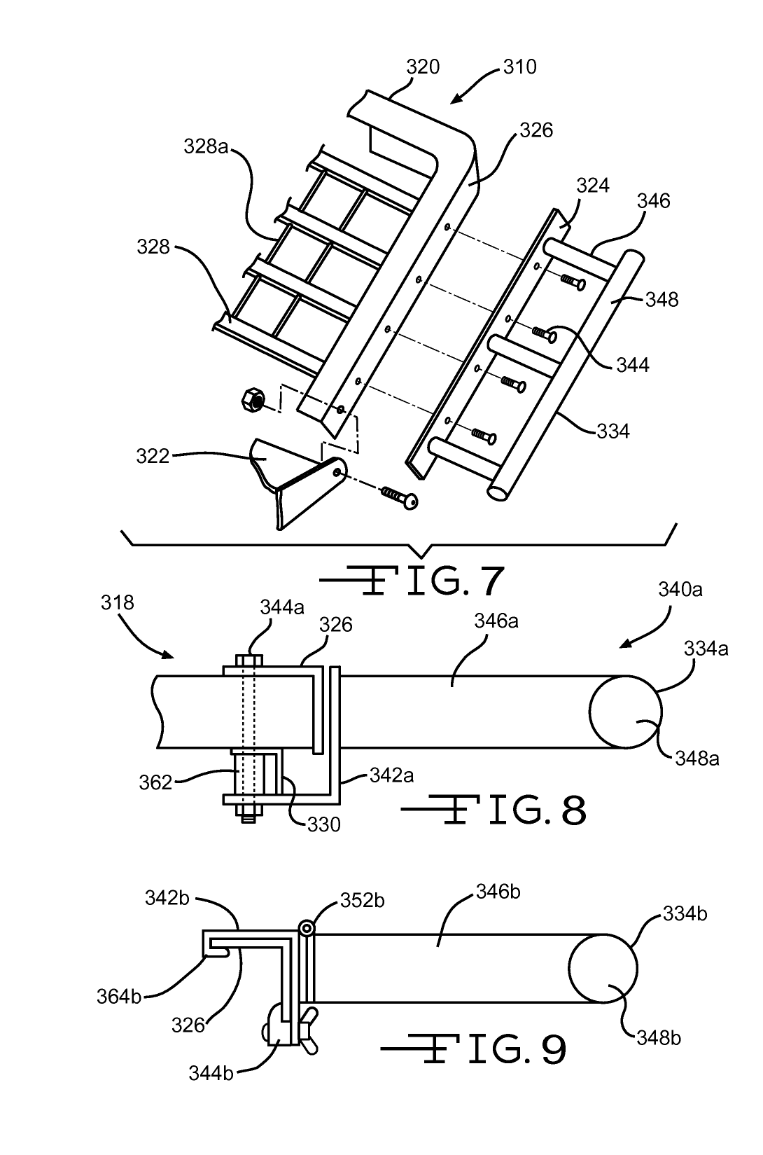

Referring to FIG. 8, a cross section of an alternative third head section extension 334a is shown. The alternative third head section extension 334a includes a mounting member 342a, an extension member 346a and a support member 348a. The mounting member 342a is attached to a mounting structure 330 on the bed 310. The mounting structure 330 is situated on the lower surface of the head section 320. Accordingly, the mounting member 342a is configured with a vertical offset. This allows the extension member 346a and the support member 348a to provide a substantially coplanar surface with a patient support surface 318 of the bed 310. Therefore, a second patient support surface 340a provided by the attachment of the alternative third head section extension 334a is generally continuous. A spacer 362 and a threaded fastener 344a are used to attach the alternative third head section extension 334a to the mounting structure 330. However, it should be appreciated that other desired fasteners may be used.

Referring now to FIG. 9, a cross section of a second alternative third head section extension 334b is shown. The second alternative third head section extension 334b includes a mounting member 342b, an extension member 346b and a support member 348b. The mounting member 342b is an angular member and includes a hooked portion 364b. The illustrated mounting member 342b is sized so that the hooked portion 364b can hook one edge of the angular member 326, while the mounting member 342b engages the other side of the angular member 326. It should be appreciated that the hooked portion 364b may extend along the full length of the mounting member 342b, or along some lesser length as desired. Also, the hooked portion 364b may include a number of separate hooked portions along the length of the mounting member 342b. The mounting member 342b also includes a clamp 344b. The clamp 344b engages another edge of the angular member 326. It should be appreciated that the clamp 344b may extend along the full length of the mounting member 342b, or along some lesser length as desired. Also, the clamp 344b may include a number of separate clamps along the length of the mounting member 342b.

The second alternative third head section extension 334b also includes a hinge connection 352b. The illustrated hinge connection 352b may allow the support member 348b to flip up relative to the mounting member 342b. This allows the support member 348b to be folded over on top of the head section 320 (e.g., counter-clockwise in FIG. 9). This allows for ease of transportation and more compact storage.

Referring now to FIG. 10, there is shown a portion of a head section 420 and a portion of a seat section 422 of a fourth bed 410. The head section 420 includes laterally spaced, substantially flat, elongate rods 426 supporting laterally extending cross members 428. The cross members 428 are generally trapezoidal in cross section, though they may be of any desired shape. The cross members 428 include a mounting structure in the form of holes 430. A fourth head section extension 434 is configured to attach to the head section 420. The fourth head section extension 434 includes a mounting member 442, two extension members 446, and a support member 448. The fourth head section extension 434 also includes two flanges 454. The flanges 454 are configured so that they align with two cross members 428 of the head section 420. The flanges 454 may be fixed relative to the cross members 428 using fasteners such as threaded fasteners 444.

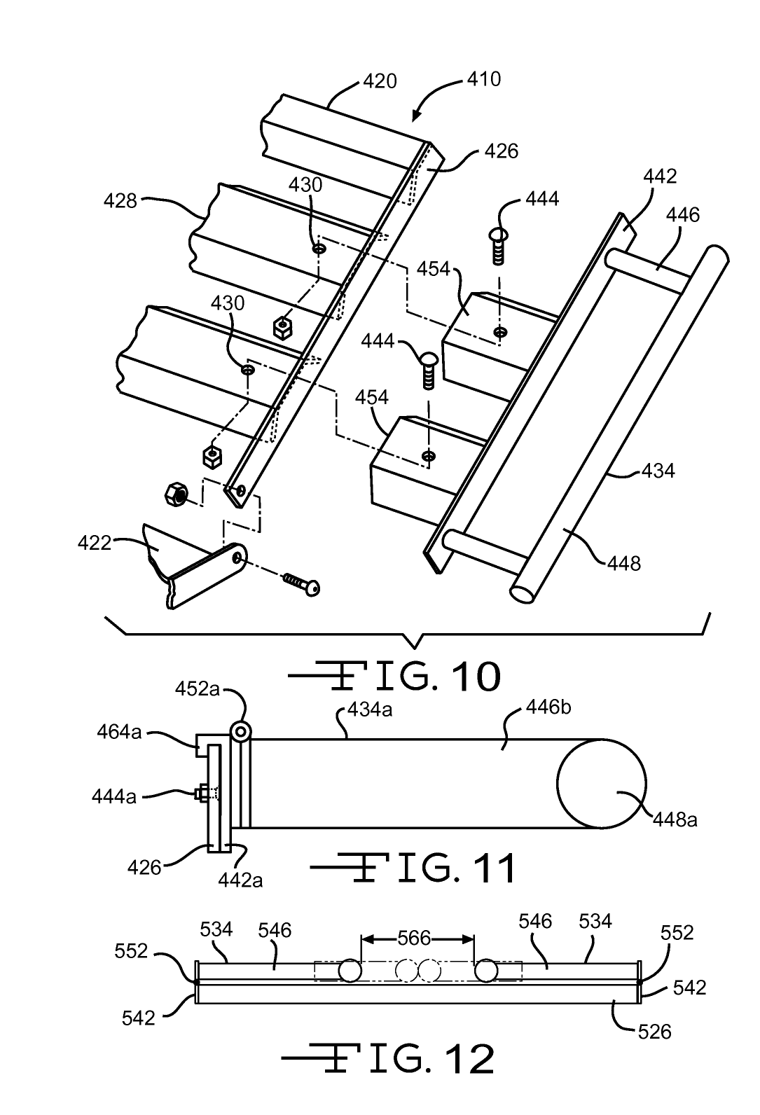

Referring to FIG. 11, a cross section of an alternative fourth head section extension 434a is shown. The alternative fourth head section extension 434a includes a mounting member 442a, an extension member 446a and a support member 448a. The mounting member 442a includes a hooked portion 464a. It should be appreciated that the hooked portion 464a may extend along the full length of the mounting member 442a, or along some lesser length as desired. Also, the hooked portion 464a may include a number of separate hooked portions along the length of the mounting member 442a. The mounting member 442a is fixed relative to the elongate rod 426 by fasteners such as threaded fasteners 444a.

The alternative fourth head section extension 434a also includes a hinge connection 452a. The illustrated hinge connection 452a may allow the support member 448a to flip up relative to the mounting member 442a. This allows the support member 448a to be folded over on top of the head section 420 (e.g., counter-clockwise in FIG. 9). This allows for ease of transportation and more compact storage.

Referring now to FIG. 12, an end view of a head section 520 including two head section extensions 534 is shown. The head section extensions 534 include mounting members 542, extension members 546 and support members 548. The head section extensions 534 include hinge connections 552 that allow the support members 548 to be folded over on top of the head section 520. The head section extensions 534 are shown folded on top of the head section 520 in FIG. 12. It should be appreciated that this allows the head section extensions 534 to be folded over on top of the head section 520 for ease of transportation and more compact storage.

The extension members 546 of the head section extensions 534 are telescopic, to allow the two support members 548 to be extended to substantially meet each other. The support members 548 are shown in their extended positions in broken line. This allows the support members 548 to substantially close a gap 566. It should be appreciated that this allows the head section extensions 534 to be folded into the storage position on top of the head section 520, while providing a continuous support surface for a mattress (not shown). It should be appreciated that while the extension members in the illustrated embodiment are telescopic the extension members may be length adjustable using other mechanisms.

It should be appreciated that a continuous support surface could be provided without the use of telescopic extensions members, for instance by providing a bridge component. The bridge may be used instead of telescopic extension members 546 to substantially fill the gap 566.

The width adjustment accessories may be any size or shape and thus are not limited to the width adjustment accessories shown and described above. Opposing width adjustment accessories can be sized to adjust the width of a bed to predetermined widths. Width adjustment accessories may be provided in different widths to permit adjustment in the width of beds to different widths. For example, a pair of opposing width adjustment accessories may each increase the width of a standard articulating bed by two inches to adjust the total width from 35 inches to 39 inches to a twin bed or provide greater comfort to the user. As yet another example, a pair of opposing width adjustment accessories may each increase the width of a standard articulating bed by six to eight inches to adjust the total width from 35 inches to 48 or 52 inches to produce a bariatric bed. Conversion of a standard articulating bed to a bariatric bed could provide a lower cost, or more cost effective, bariatric bed.

It should be appreciated that a width adjustment accessory need not have a mounting member that mechanically locks onto the moveable sections but instead may have a mounting member that simply hooks onto the moveable sections and/or is held in relation to the moveable sections by the patient's weight and/or the weight of the width adjustment accessory. It should also be appreciated that the width adjustment accessory need not be mounted to the movable sections but instead may be mounted in relation to the main frame.

It should be appreciated that the width adjustment accessory may be mounted to the bed via use of auxiliary component mounting structure and may be provided with structure for mounting the auxiliary component (e.g., hand rail) so as to effectively translate the mounting points of the auxiliary component to the width adjustment accessory. Hence, the width adjustment accessory may permit use of the same components that would otherwise attach directly to the bed.

It should be appreciated that three width adjustment accessories may be mounted along each side of beds having a patient support surface comprising four sections (e.g., head, seat, knee and foot sections). Hence, a width adjustment accessory can be eliminated at the seat section, which simplifies assembly and retrofit application of the width adjustment accessories.

It should further be appreciated that in some embodiments the width adjustment accessory may be mounted without tools.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A bed comprising:
a frame including a substantially planar frame support surface; and
a width adjustment accessory including a mounting member and an extension member, the extension member providing a substantially planar extended support surface, the mounting member configured to be attached relative to the frame so that the extended support surface is substantially planar with the frame support surface.

2. The bed of claim 1, the width adjustment accessory further comprising an accessory mounting structure.

3. The bed of claim 1, further comprising a second width adjustment accessory including a second mounting member and a second extension member, the second extension member providing a second substantially planar extended support surface, the second mounting member configured to be attached relative to the frame so that the second extended support surface is substantially planar with the frame support surface;
wherein the mounting member and the second mounting member are configured to be attached on opposite sides of the frame support surface.

4. The bed of claim 3, the width adjustment accessory further comprising an accessory mounting structure.

5. The bed of claim 1, wherein the substantially planar frame support surface is a head support surface and wherein the bed further includes:
a body frame support surface; and
a body width adjustment accessory including a body mounting member and a body extension member, the body extension member providing a body substantially planar extended support surface, the body mounting member configured to be attached relative to the frame so that the body extended support surface is substantially planar with the body frame support surface.

6. The bed of claim 5, wherein the bed is articulated and the head frame support surface is moveable relative to the body frame support surface and wherein the width adjustment accessory remains substantially planar with the head frame support surface and the body width adjustment accessory remains substantially planar with body frame support surface.

7. The bed of claim 6, further comprising:
a second head width adjustment accessory including a second head mounting member and a second head extension member, the second head extension member providing a second substantially planar head extended support surface, the second head mounting member configured to be attached relative to the frame so that the second head extended support surface is substantially planar with the head frame support surface, the head mounting member and the second head mounting member configured to be attached on opposite sides of the head support surface; and
a second body width adjustment accessory including a second body mounting member and a second body extension member, the second body extension member providing a second substantially planar body extended support surface, the second body mounting member configured to be attached relative to the frame so that the second body extended support surface is substantially planar with the body frame support surface, the body mounting member and the second body mounting member configured to be attached on opposite sides of the body frame support surface.

8. The bed of claim 7, the width adjustment accessory further comprising an accessory mounting structure.

9. The bed of claim 8, the width adjustment accessory further comprising a hinge connection attached to one of the mounting member and the extension member.

10. The bed of claim 9, wherein the hinge connection is configured to allow the extension member to rotate onto the frame support surface.

11. The bed of claim 10, wherein the extension member has an adjustable latitudinal length.

12. The bed of claim 1, wherein the frame support surface is configured to support a first mattress and the frame support surface and extended support surface combined are configured to support a second mattress of greater width than the first mattress.

13. An accessory for use with beds, the accessory comprising:
a width adjustment accessory including a mounting member, and an extension member attached to the mounting member, the extension member providing a substantially planar extended support surface; and
a second width adjustment accessory including a second mounting member, and a second extension member attached to the second mounting member, the second extension member providing a substantially planar second extended support surface;
the width adjustment accessory and second width adjustment accessory configured to be mounted on opposite sides of a frame support surface, so that the extended support surface and the second extended support surface are substantially planar with the frame support surface.

14. The accessory of claim 13, wherein the width adjustment accessory is a head width adjustment accessory and the second width adjustment accessory is a second head width adjustment accessory;
further comprising a body width adjustment accessory including a body mounting member, and a body extension member attached to the body mounting member, the body extension member providing a substantially planar body extended support surface; and
a second body width adjustment accessory including a second body mounting member, and a second body extension member attached to the second body mounting member, the second body extension member providing a substantially planar second body extended support surface;
the body width adjustment accessory and second body width adjustment accessory configured to be mounted on opposite sides of a body frame support surface, so that the body extended support surface and the second body extended support surface are substantially planar with the body frame support surface.

15. The accessory of claim 14, the width adjustment accessory further comprising an accessory mounting structure.

16. The accessory of claim 14, the width adjustment accessory further comprising a hinge connection attached to one of the mounting member and the extension member.

17. The accessory of claim 16, wherein the hinge connection is configured to allow the extension member to rotate onto the frame support surface.

18. The accessory of claim 17, wherein the extension member has an adjustable latitudinal length.

19. The accessory of claim 17, the width adjustment accessory further comprising an accessory mounting structure.

20. A bed comprising:
a frame supporting a substantially planar head frame support surface, a substantially planar body frame support surface, and a substantially planar foot frame support surface;
a head extension that includes a head mounting member and a head extension member, the head extension member defining a substantially planar head extended surface, the head extension configured to attach relative to the frame so that the head extended support surface is substantially planar with the head frame support surface;
a second head extension that includes a second head mounting member and a second head extension member, the second head extension member defining a substantially planar second head extended surface, the second head extension configured to attach relative to the frame so that the second head extended support surface is substantially planar with the head frame support surface;
a body extension that includes a body mounting member and a body extension member, the body extension member defining a substantially planar body extended surface, the body extension configured to attach relative to the frame so that the body extended support surface is substantially planar with the body frame support surface;
a second body extension that includes a second body mounting member and a second body extension member, the second body extension member defining a substantially planar second body extended surface, the second body extension configured to attach relative to the frame so that the second body extended support surface is substantially planar with the body frame support surface;
a foot extension that includes a foot mounting member and a foot extension member, the foot extension member defining a substantially planar foot extended surface, the foot extension configured to attach relative to the frame so that the foot extended support surface is substantially planar with the foot frame support surface; and
a second foot extension that includes a second foot mounting member and a second foot extension member, the second foot extension member defining a substantially planar second foot extended surface, the second foot extension configured to attach relative to the frame so that the second foot extended support surface is substantially planar with the foot frame support surface;
wherein the bed is articulated and the head frame support surface is moveable relative to the body frame support surface and wherein the body width adjustment accessory and the second width adjustment accessory remain substantially planar with the head frame support surface and the body width adjustment accessory and the second body width adjustment accessory remain substantially planar with body frame support surface.
